(19) United States
(12) Patent Application Publication
(10) Pub. No.: US 2019/0323598 A1
(43) Pub. Date: Oct. 24, 2019

(54) OPERATING MODULE FOR A MOTOR VEHICLE

(71) Applicant: ZF FRIEDRICHSHAFEN AG, Friedrichshafen (DE)

(72) Inventor: Joachim KORHERR, Orsingen (DE)

(73) Assignee: ZF Friedrichshafen AG, Friedrichshafen (DE)

(21) Appl. No.: 16/312,804

(22) PCT Filed: Jul. 5, 2017
(86) PCT No.: PCT/EP2017/066759

§ 371 Date: Dec. 21, 2018

(30) Foreign Application Priority Data
Jul. 5, 2016 (DE) 10 2016 112 277.7

(51) Int. Cl. F16H 59/10; H01H 17/04

(52) U.S. Cl. CPC F16H 59/105; F16H 2059/0247; H01H 17/04

(57) ABSTRACT

An operating assembly unit for a motor vehicle may include a switch for shifting speed levels of an automatic motor vehicle transmission. The switch may include a first lever that is manually operable, a second lever mechanically coupled to the first lever, and a switching element. The first lever may be movable to actuate the electrical switching element by causing contact between the electrical switching element and the second lever. The second lever may include a leaf spring with a clamped end and a free end. The actuation of the first lever may deform the leaf spring such that at least a portion of the leaf spring is displaced towards the switching element.

### RELATED APPLICATIONS

This application is a filing under 35 U.S.C. § 371 of International Patent Application PCT/EP2017/066759, filed Jul. 5, 2017, and claiming priority to German Patent Application 10 2016 112 277.7, filed Jul. 5, 2016. All applications listed in this paragraph are hereby incorporated by reference in their entireties.

### TECHNICAL FIELD

The invention relates to an operating assembly unit for a motor vehicle, comprising an electrical switch, in particular for the changing of speed levels of an automatic motor vehicle transmission, wherein the switch comprises a first, manually operable lever, a second lever and an electrical switching element and wherein the first lever actuates the electrical switching element via the second lever in its actuated state.

### BACKGROUND

Operating assembly units with electrical switches are widely used in the field of motor vehicles. Usually, these are used to operate a radio, a navigation system and/or an on-board computer.

Another field of application of the operating assembly units and of the associated electrical switches is the operation of motor vehicle transmissions. The electrical switches are hereby preferably used in connection with automatic motor vehicle transmissions. A driver can thereby manually shift or select speed levels of the automatic vehicle transmission by means of an electrical switch. If such electrical switches for the shifting of speed levels of an automatic vehicle transmission are components of a steering wheel assembly group, they are often referred to as paddle shifters. In such a case, the driver does not have to take his hands from the steering wheel in order to shift gears, so that he can also maneuver the vehicle in a safe manner while he is operating an electrical switch.

Furthermore, operating assembly units with electrical switches are known, which are incorporated into speed level selecting elements that are arranged within the center console of a motor vehicle.

An operating assembly unit of the before-mentioned type is e.g. known from the DE 10 2012 014 019 A1. In this operating assembly unit, great emphasis was placed on the fact that the actuating travel path of a paddle shifter is short and that a fast and safe shifting of the speed levels is possible at the same time.

Another operating assembly unit, which is designed with a paddle shifter, is known from the US 2014/0000404 A1.

In known operating assembly units, electric switches are used, which are operated mechanically, e.g. by means of levers. Such switching elements are usually sensitive to excessive mechanical load. Such an excessive load can e.g. occur, when a switching element is operated with too much force or when an actuating travel path of a lever that is actuating the switching element is too long. In such a case, moving parts of the switching element are inadvertently brought into contact with stationary parts of the switching element. This is referred to as “overtravel” of the actuating lever.

Due to such excessive load on the switching element, it is possible that its function can be disrupted and/or its life span can be shortened. The components for operating assembly units of the before-mentioned type are thus always manufactured in compliance with low tolerances in the prior art. In particular the levers that are actuating the switching element are manufactured with low tolerances, in order to facilitate a long life span and a reliable function of the switching element.

If a switching element is operated via several levers, a tolerance chain is formed. In this case, it is necessary to adjust the sum of the tolerances in such a way that the switching element is not impaired in its function.

On the other hand, the objective for operating assembly units of the before-mentioned type is to configure these as simple as possible and to manufacture these in a cost-efficient way. This obviously leads to a conflict of objectives with regard to the compliance with low tolerances.

### BRIEF DESCRIPTION OF THE DRAWINGS

In the following, the invention is explained with reference to various embodiments, which are depicted in the accompanying drawings.

FIG. 1 is an illustration showing, in a schematic way, a first embodiment of an operating assembly unit according to the invention in an unactuated state.

FIG. 2 is an illustration showing, a schematic way, the first embodiment of an operating assembly unit according to the invention from FIG. 1 in an actuated state.

FIG. 3 is an illustration showing, a second embodiment of an operating assembly unit according to the invention in a perspective, sectionally cut depiction.

### DETAILED DESCRIPTION

It is thus the objective of the present invention to create an operating assembly unit of the before-mentioned type, which is simple in its construction and which functions in a reliable manner. At the same time, it should be possible to manufacture the operating assembly unit in a cost-efficient manner. While accomplishing this, an electrical switching element should be protected particularly against excessive load, e.g. “overtravel”.

This objective is achieved by means of an operating assembly unit of the before-mentioned type, in which the second lever is a leaf spring with one end being firmly clamped and with one free end, and an actuating of the first lever deforms the leaf spring in such a way that it is at least sectionally displaced towards the switching element. The leaf spring thus actuates the switching element. The switching element can hereby refer to any electrical component, in particular to a micro-switch. The switching element can e.g. be arranged on a circuit board. The operating assembly unit is designed in a simple manner.

Preferably, the at least sectional displacing the leaf spring is limited by a limit stop. In this way it is prevented that the leaf spring exerts a too strong force on the electrical switching element or that it impacts on the switching element with a too long actuating travel path. The electrical element is thus protected against excessive load, in particular against “overtravel”. This results in an extended life span of the electrical switching element and thus of the entire operating assembly unit. At the same time, it is possible that the components of the operating assembly unit, in particular the levers that are actuating the switching element, feature higher tolerances. Thus, these can be manufactured in a cost-efficient manner.

In one embodiment, the limit stop is positioned between the switching element and the free end of the leaf spring, when viewed in the direction of the extension of the leaf spring. In other words, the switching element is located between the limit stop and the firmly clamped end of the leaf spring. The switching element is thus positioned in a protected position. In addition to this, the operating assembly unit is thus very compact.

Advantageously, a contact point of the first lever is positioned at the leaf spring between the limit stop and the free end of the leaf spring. With regard to the switching element, the contact point is located on the opposite side of the limit stop. The switching element is thus effectively protected against excessive load.

According to one design variant, the limit stop is fastened to a carrier element of the switch and preferably designed in one single piece along with the carrier element. The carrier element may e.g. refer to a part that is made of plastic material, which is preferably manufactured by means of the injection molding procedure. The number of components of the operating assembly unit is thus reduced and as a result its design structure is simplified.

The limit stop is preferably a protrusion at the carrier element. The limit stop may hereby refer to e.g. a wall- or pin-shaped protrusion.

According to one embodiment, the leaf spring includes a stiffened section, which is preferably located opposite to the switching element. The stiffened section is rigid when compared to the other sections of the leaf spring. This means that when a force is exerted on the leaf spring, the remaining portions of the leaf spring deform first. The stiffened section can thus be moved in a defined manner and can particularly interact with the electrical switching element in a defined manner. Furthermore, a bulging of the leaf spring is prevented in the area of the stiffened section. The stiffened section is preferably located between the firmly clamped end of the leaf spring and the limit stop. It is thus located opposite of the switching element and the switching element is actuated by means of the stiffened section. An excessive load to the switching element is thus effectively prevented. The stiffened section can be implemented e.g. by means of a thickening of the material or a material forming.

The stiffened section may include a lug, which is bent at an angle around a bending line that is oriented mainly along the extension of the leaf spring, it is preferably bent at an essentially right angle. The lug is hereby preferably bent towards the side that is opposite to the switching element. By means of this bending, an increased stiffness of the leaf spring is ensured in the stiffened section. At an angle of 90°, a particularly high bending stiffness is achieved. The lug can also be angled by for example 180°, so that the leaf spring is double layered in the stiffened section.

One design example intends that the leaf spring exerts a resetting force on the first lever in the direction of its unactuated state. The resetting force is the result of an elastic deforming of the leaf spring in conjunction with the firm clamping of one end of the leaf spring. The entire operating assembly unit is thus pre-tensioned into an unactuated state.

According to a design alternative, the switching element is arranged between the firmly clamped end and the free end of the leaf spring, when seen in the direction of the extension of the leaf spring, wherein the switching element is preferably arranged closer to the firmly clamped end. This results in a compact design of the operating assembly unit.

The first lever and the switching element may furthermore be arranged on opposite sides of the leaf spring. In this way, only a relatively small installation space is required.

In one variant, the switching element is a micro-switch.

In accordance with one embodiment, the first lever is a paddle shifter, which can preferably be arranged on a steering wheel of a motor vehicle. Alternatively, the first lever may also refer to a lever with another application, for example that of a control device for a radio, a navigation system or an on-board computer. The first lever can also be an intermediate lever of one of the before-mentioned applications.

In one design alternative, the first lever is a selecting element for a speed level, which is preferably arranged in a center console of a motor vehicle. The first lever can also be a lever of another application, such as that of a radio, a navigation system and an on-board computer.

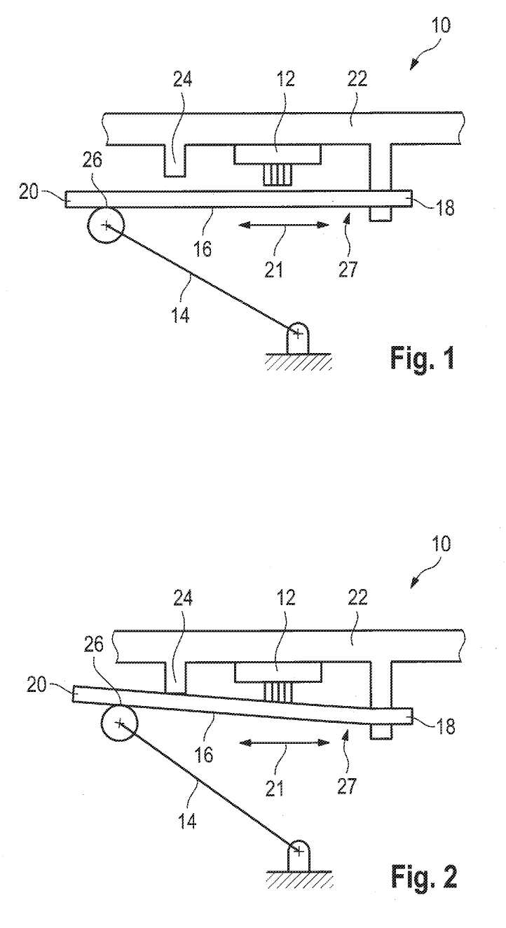

An operating assembly unit 10 is shown in FIG. 1, in which an electrical switching element 12, in the depicted embodiment a micro-switch, is actuated via a first lever 14 and a second lever. The second lever is a leaf spring 16, which comprises a firmly clamped end 18 and a free end 20.

In the depicted embodiment, the first lever 14 can be formed at a gear stage selecting element, which is e.g. arranged in the center console of a motor vehicle, or at a paddle shifter that is arranged at a steering wheel of a motor vehicle.

Leaf spring 16 extends along a direction as it is shown by an arrow 21.

The electrical switching element 12 is thereby mounted within a carrier element 22, in which the firmly clamped end 18 of the leaf spring 16 is mounted as well.

A limit stop 24 is furthermore arranged at carrier element 22. It is connected to carrier element 22 in a single-piece manner and it is designed as a protrusion. Limit stop 24 serves to limit the displacing motion of leaf spring 16 in the direction of the electrical switching element 12.

Along the direction in which leaf spring 16 extends, as it is indicated by arrow 21, the components in the operating assembly unit 10 are arranged as follows, starting with the clamped end of leaf spring 16: clamped end 18 of leaf spring 16, switching element 12, limit stop 24, free end 20 of leaf spring 16.

Electrical switching element 12 is hereby positioned closer to the firmly clamped end 18 than to the free end 20 of leaf spring 16.

The first lever 14 engages at a contact point 26 between limit stop 24 and the free end 20 on leaf spring 16. Other than that, the first lever 14 and switching element 12 are arranged on opposite sides of leaf spring 16.

The respective portion of leaf spring 16, which is located opposite to switching element 12 or between the firmly clamped end 18 and limit stop 24, is designed as a stiffened section 27. It is stiffer than the remaining sections of leaf spring 16 and is thus less bendable.

In FIG. 1, the operating assembly unit 10 is shown in the unactuated state, which means that leaf spring 16 does not actuate switching element 12. Thus, a distance exists between limit stop 24 and leaf spring 16. The function principle of operating assembly unit 10 is explained with reference to the FIGS. 1 and 2 in the following.

In order to actuate the operating assembly unit 10, the first lever 14 is actuated manually. It thereby shifts in clockwise direction in the illustrated embodiment and exerts an actuating force onto leaf spring 16 at contact point 26.

As a result, leaf spring 16 deforms elastically, wherein the stiffened section 27 is basically not deformed, but only the remaining sections of leaf spring 16.

Due to the sectional deformation of leaf spring 16, in particular of the section around the firmly clamped end 18, leaf spring 16 is sectionally displaced into the direction of switching element 12. The focus is hereby in particular on the displacing of stiffened section 27 into the direction towards switching element 12.

As soon as the stiffened section 27 has been displaced sufficiently far into the direction of switching element 12, it is actuated.

If it is displaced any further, leaf spring 16 touches limit stop 24, so that a further displacing of stiffened section 27 is blocked. As a result, switching element 12 is protected against an excessive load.

If the first lever 14 continues to be actuated and leaf spring 16 is exposed to more actuating force at contact point 26, only the section of leaf spring 16 between the free end 20 and limit stop 24 is deformed.

Leaf spring 16 is only deformed in an elastic way at any time.

If the first lever 14 is no longer manually operated, it also stops to exerts any actuating force onto leaf spring 16. In this case, leaf spring 16 elastically deforms back to its unactuated state. It hereby exerts a restoring force onto the first lever 14, so that it also returns to its unactuated state.

After these restoring movements, the entire operating assembly unit 10 is back in the unactuated state.

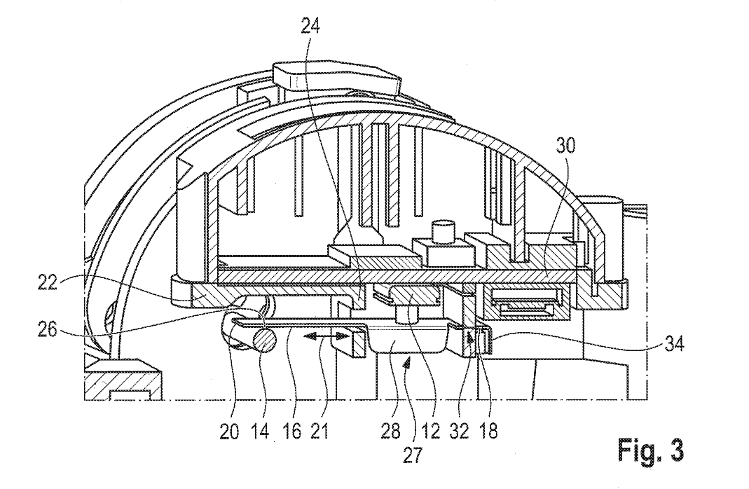

FIG. 3 shows a further embodiment of the operating assembly unit 10. In the following, reference is only made to the differences of the embodiment shown in the FIGS. 1 and 2.

In the embodiment according to FIG. 3, the first lever 14 is formed at a gear stage selecting element, which is e.g. arranged in the center console of a motor vehicle, or at a paddle shifter that is arranged at a steering wheel of a motor vehicle.

The stiffened section 27 of leaf spring 16 comprises a bent lug 28, wherein lug 28 is basically bent at an angle of 90° with reference to the rest of leaf spring 16 and the bending is carried out along a bending line, which basically extends along the direction of the extension of leaf spring 16 as it is indicated by arrow 21.

By means of the angled lug 28, the bending stiffness of the stiffened section 27 is increased in comparison to the other sections of leaf spring 16.

In the embodiment according to FIG. 3, switching element 12 is arranged on an electrical circuit board 30 (PCB). Circuit board 30 is mounted on carrier element 22.

Leaf spring 16 furthermore features an incision 32 in the particular section, in which it is firmly clamped at carrier element 22. In this way, carrier element 22 and leaf spring 16 are connected in a form-fit manner. Thus, the leaf spring can be precisely positioned at carrier element 22. At the same time, the connection is insensitive to shocks.

Incision 32 can also be used to adjust the local bending stiffness of leaf spring 16. A larger incision, i.e. an incision that is deeper in a transverse direction of leaf spring 16, which extends deeper in perpendicular direction to the direction indicated by arrow 21, hereby produces a lower local bending stiffness.

In addition to this, the firmly clamped end 18 of leaf spring 16 in the embodiment according to FIG. 3 is provided with an angled portion 34. The contacting surface of leaf spring 16 at carrier element 22 is enlarged in this way. A greater counter bearing is thus created for the actuating forces that are exerted onto leaf spring 16 by the first lever 14.

The bending 34 can also be used for the positioning of leaf spring 16 at carrier element 22. This simplifies the mounting of leaf spring 16.

The actuating and resetting of the operating assembly unit 10 according to FIG. 3 is carried out in the same manner as in the embodiment described in the FIGS. 1 and 2.

1. An operating assembly unit for a motor vehicle, the operating assembly unit comprising a switch for shifting speed levels of an automatic motor vehicle transmission, wherein the switch comprises:
a first lever that is manually operable lever;
a second lever mechanically coupled to the first lever; and
a switching element,
wherein the first lever is movable to actuate the electrical switching element by causing contact between the electrical switching element and the second lever,
wherein the second lever includes a leaf spring with a clamped end and a free end, and
wherein the actuation of the first lever deforms the leaf spring such that at least a portion of the leaf spring is displaced towards the switching element.

2. The operating assembly unit of claim 1, wherein the displacement of the leaf spring is limited by a limit stop.

3. The operating assembly unit of claim 2, wherein the limit stop is positioned between the shifting element and the free end of the leaf spring when viewed in the longitudinal direction of the leaf spring.

4. The operating assembly unit of claim 2, wherein a contact point between the leaf spring and the first lever is located between the limit stop and the free end of the leaf spring.

5. The operating assembly unit of claim 2, wherein the limit stop is fastened to a carrier element of the switch.

6. The operating assembly unit of claim 5, wherein the limit stop includes a protrusion extending from a portion of the carrier element.

7. The operating assembly unit of claim 1, wherein the leaf spring includes a stiffened section located adjacent to the switching element.

8. The operating assembly unit of claim 7, wherein the stiffened section includes a lug, wherein the lug is bent at an angle around a bending line that is parallel to the longitudinal direction of the leaf spring.

9. The operating assembly unit of claim 1, wherein the leaf spring exerts a resetting force on the first lever in the direction of a default state of the first lever.

10. The operating assembly unit of claim 1, wherein the shifting element is arranged between the clamped end of the leaf spring and the free end of the leaf spring, and wherein the shifting element is arranged closer to firmly clamped end than the free end.

11. The operating assembly unit of claim 1, wherein the first lever and the shifting element are arranged on opposite sides of the leaf spring.

12. The operating assembly unit of claim 1, wherein the switching element is a micro-switch.

13. The operating assembly unit of claim 1, wherein the first lever is a paddle shifter.

14. The operating assembly unit of claim 1, wherein the first lever is a selecting element for a speed level.

15. The operating assembly unit of claim 5, wherein the limit stop is integral with the carrier element.

16. The operating assembly unit of claim 1, wherein the first lever is movable by a steering wheel of the motor vehicle.

17. A switch for changing a setting of a motor vehicle transmission, the switch comprising:
a first lever that is manually operable;
a second lever mechanically coupled to the first lever; and
an electrical switching element,
wherein the first lever is movable to actuate the electrical switching element by causing contact between the electrical switching element and the second lever,
wherein the second lever includes a leaf spring with a clamped end and a free end, and
wherein the actuation of the first lever deforms the leaf spring such that at least a portion of the leaf spring is displaced towards the switching element.

18. The switch of claim 17, wherein the displacement of the leaf spring is limited by a limit stop.

19. The switch of claim 18, wherein the limit stop is positioned between the shifting element and the free end of the leaf spring when viewed in the direction of the extension of the leaf spring.

20. The switch of claim 18, wherein a contact point between the leaf spring and the first lever is located between the limit stop and the free end of the leaf spring.
